(19) United States
(12) Patent Application Publication
(10) Pub. No.: US 2024/0287262 A1
(43) Pub. Date: Aug. 29, 2024

(54) Thermoplastic polymer powder for 3D printing with improved stability and recyclability

(71) Applicant: ARKEMA FRANCE, COLOMBES (FR)

(72) Inventors: Ornella ZOVI, Serquigny (FR); Jean-Charles DURAND, Serquigny (FR)

(73) Assignee: ARKEMA FRANCE, COLOMBES (FR)

(21) Appl. No.: 18/573,213

(22) PCT Filed: Jun. 28, 2022
(86) PCT No.: PCT/FR2022/051284

§ 371 Date: Dec. 21, 2023

(30) Foreign Application Priority Data
Jun. 29, 2021 (FR) FR2106981

(51) Int. Cl. C08J 3/12; B29C 64/314; B29K 45/00; B29K 77/00; B29K 105/00; B29K 105/16; B33Y 70/00; C08K 5/134; C08K 5/20; C08K 5/372; C08K 5/42

(52) U.S. Cl. CPC C08J 3/12; B29C 64/314; B33Y 70/00; C08K 5/1345; C08K 5/20; C08K 5/372; C08K 5/42; B29K 2045/00; B29K 2077/00; B29K 2105/0094; B29K 2105/16; B29K 2105/251; B29K 2995/004; B29K 2995/0094; C08J 2377/02

(57) ABSTRACT

The present invention relates to a polymer powder for the manufacture of articles by 3D printing, particularly by sintering, comprising a thermoplastic polymer and a particular antioxidant having improved stability and recyclability. The invention also relates to a process for preparing this powder and to the use thereof in a process for manufacturing by sintering, and to the articles manufactured from said powder.

### FIELD OF THE INVENTION

The present invention relates to a polymer powder for the manufacture of articles by 3D printing, particularly by sintering, comprising a thermoplastic polymer and a particular antioxidant having improved stability and recyclability.

The invention also relates to a process for preparing this powder and to the use thereof in a process for manufacturing by sintering, and to the articles manufactured from said powder.

### TECHNICAL BACKGROUND

There are various 3D printing techniques that use a polymer powder composition. The principle is generally based on the agglomeration of powders, layer by layer, by melting said layer (hereinafter “sintering”) brought about by electromagnetic radiation, for example, a laser beam (laser sintering), infrared radiation, UV radiation, or any source of electromagnetic radiation which makes it possible to melt the powder layer by layer in order to manufacture three-dimensional objects.

Mention may be made of Selective Laser Sintering (SLS) technology. Mention may also be made of sintering technologies using an absorber, for example the technologies known under the names “High Speed Sintering” (HSS) and “Multi-Jet Fusion” (MJF).

For sintering processes such as SLS or MJF, the use of thermoplastic polymer powder, for example a polyamide powder, is favored.

During each build in a sintering process, also known as a run, a large portion of the powder is unused: for example, approximately 85% of the powder is not targeted by the laser in SLS, or else by infrared in MJF, and therefore is non-agglomerated and/or not melted. It is thus advantageous to be able to reuse, i.e. to recycle, this powder during the next build (or next run).

However, when the sintering process is conducted under air, for example in an MJF process, the presence of oxygen at a high temperature may bring about thermo-oxidative degradation of the polymer, causing undesirable yellowing of the powder and consequently yellowing of the printed parts, which prevents the non-agglomerated powder from being re-used.

There is a need to provide a thermoplastic polymer powder having good thermal stability, more particularly in a process for sintering under air, in order to be recyclable.

For the purposes of the present invention, thermal stability means reduced thermo-oxidative degradation; namely in particular limited yellowing of the powder that has not agglomerated during the sintering.

It is known to employ an antioxidant in a powder formulation in order to improve recyclability of the powder and/or to limit yellowing thereof.

Document CN104910616 describes a powder of an elastomer based on polyamide 12, comprising flexible segments synthesized from dodecanedioic acid, doubly amine-terminated polyethylene glycol, and deuterated trifluoroacetic acid. The powder may further comprise an antioxidant of phenolic, phosphite or thioether type.

Document FR 3087198 describes a powder intended for 3D printing, based on thermoplastic polymer, comprising at least 0.1% by weight of at least one thioether antioxidant relative to the total weight of powder.

However, the antioxidant effect of the abovementioned compounds has not always proven to be satisfactory.

The aim of the present invention is to provide a solution to one or more of the abovementioned problems.

More particularly, the aim of the invention is to provide a thermoplastic polymer powder, preferably a polyamide powder, comprising a particular antioxidant and having improved thermal stability and also improved recyclability.

In the context of the present invention, a powder having improved thermal stability means a powder having a yellowness index (YI), measured after having been exposed under air at 177° C. in a volume of approximately 50 ml for 72 h, that is at least 30% less than the index measured under the same conditions for the same powder without the particular antioxidant.

### SUMMARY OF THE INVENTION

According to a first aspect, the present invention relates to a polymer powder suitable for 3D printing by sintering, comprising a thermoplastic polymer (a), preferably a polyamide, and an aliphatic sulfonate (b) according to formula R—SO₃X, or aromatic sulfonate (b) according to formula R—Y—SO₃X, wherein
R represents a linear or branched, saturated or unsaturated aliphatic carbon-based chain having 4 to 30 carbon atoms, which may comprise a group (particularly a single group) chosen from ester, amide, carboxylic acid, alcohol, nitrile, ketone and/or aldehyde, preferably chosen from ester, amide, carboxylic acid and alcohol (it being possible in particular for R to consist of a linear or branched, saturated or unsaturated aliphatic carbon-based chain having 4 to 30 carbon atoms),
Y represents one or more aromatic rings,
X represents a monovalent ion chosen from the alkali metals, preferably a sodium ion.

Typically, the sulfonate according to the invention can be chosen from:
an aliphatic sulfonate comprising a linear or branched saturated carbon-based chain having 4 to 12 carbon atoms, preferably 6 to 10 carbon atoms, for example sodium hexanesulfonate, sodium heptanesulfonate, sodium octanesulfonate, sodium nonanesulfonate, sodium decanesulfonate, sodium undecanesulfonate, sodium dodecanesulfonate;
an aliphatic sulfonate comprising a linear or branched unsaturated carbon-based chain having 4 to 30 carbon atoms, preferably 12 to 18 carbon atoms, for example a sodium sulfonate olefin having 12 to 18 carbon atoms; and/or
an aliphatic or aromatic sulfonate comprising a linear or branched, saturated or unsaturated carbon-based chain having 4 to 30 carbon atoms, the chain comprising a group (particularly a single group) chosen from ester, amide, acid, alcohol, nitrile and/or aldehyde, preferably chosen from ester, amide, acid and alcohol.

The aliphatic sulfonate may for example comprise a saturated or unsaturated carbon-based chain having 4 to 30 carbon atoms, preferably having 4 to 20 carbon atoms, comprising an ester or amide group.

By way of example, mention may be made of the commercial products Hostapon® SCI 85 P, Hostapon® TPHC.

The aromatic sulfonate may for example be an alkylbenzene sulfonate in which the benzene is substituted by at least one linear or branched, saturated or unsaturated carbon-based chain having 4 to 18 carbon atoms, for example dodecylbenzene sulfonate.

Preferably, the sulfonate has a melting point of less than 300° C., preferably less than 250° C., more preferentially less than 200° C., and in particular less than that of the polymer powder.

The thermoplastic polymer of use according to the invention mat be chosen from: polyolefin, polyamide, polyester, polyaryletherketone, polyphenylene sulfide, polyacetal, polyimide, polyvinylidene fluoride, and/or a mixture thereof, preferably polyamide, polyaryletherketone and/or the mixture thereof.

Preferably, the thermoplastic polymer according to the invention is a semicrystalline thermoplastic polymer.

According to one embodiment, the polymer powder further comprises a thioether, fillers or reinforcements and/or one or more additional additives.

In the context of the present invention, it has been observed that the use of a sulfonate as defined above in a thermoplastic polymer powder, preferably a polyamide powder, made it possible to improve the thermal stability of said powder while retaining acceptable mechanical properties during successive builds.

More particularly, the addition of the sulfonate makes it possible to highly advantageously limit yellowing of the powder over successive builds.

Highly advantageously, this improvement in thermal stabilization has been observed not only on the powder but also on the printed part.

Moreover, it has been observed that the presence of sulfonate makes it possible to prevent too great an increase in the inherent viscosity of the non-agglomerated powder, and thus makes it possible to increase recyclability of the powder in a sintering process and ultimately makes it possible to obtain 3D parts with efficient mechanical properties.

The present invention thus proposes a powder having excellent recyclability, even when the sintering process is conducted under harsh conditions, typically under air at high temperature (namely a few tens of degrees below the melting point) and/or for a prolonged build time.

According to one embodiment, the polymer powder according to the invention comprises a thermoplastic polymer (a), a sulfonate (b), and optionally a thioether (c), fillers or reinforcements (d), and/or one or more additional additives (e).

According to one aspect, the invention is targeted at a process for preparing a powder as defined above.

Another subject of the present invention is the use of a sulfonate for improving the thermal stability, preferably for limiting yellowing, of a thermoplastic polymer powder suitable for 3D printing by sintering.

According to one embodiment, the polymer powder further comprises a thioether.

The present invention also relates to a 3D printing process, preferably a process of sintering brought about by electromagnetic radiation, using the powder as defined above, or a powder comprising a non-agglomerated portion of said powder recovered after one or more builds within the same printing process or a different printing process.

The electromagnetic radiation is preferably chosen from a laser beam, infrared radiation or UV radiation, with or without an absorber.

The present invention also relates to an article obtained by the 3D printing process as defined above.

The article may be chosen from prototypes, models and parts, particularly in the automotive, nautical, aeronautical, aerospace, medical (prostheses, hearing systems, cell tissues, etc.), textile, clothing, fashion, decoration, design, electronic housing, telephony, computing, lighting, sport and industrial tool sectors.

Preferably, the inherent viscosity in solution (also referred to as “inherent viscosity”) of the printed part is greater than 0.8, such that the article has acceptable mechanical properties. More preferably, the inherent viscosity of the printed part is greater than 1.0. Generally, the inherent viscosity of the printed part is less than 4.0, preferably less than 3.0.

The invention is now described in detail and non-limitingly in the following description.

### DESCRIPTION OF THE INVENTION

### Definition

In the present description of the invention, including in the examples below: Dv50, also referred to herein as the “volume-median diameter”, corresponds to the value of the particle size which divides the population of particles examined exactly in two. The Dv50 is measured according to the standard ISO 13320-1. In the present description, a Malvern Insitec particle size analyzer with RTSizer software is used to obtain the particle size distribution of the powder and to deduce the Dv50 therefrom.

The inherent viscosity in solution (particularly of the polyamide, of the polyamide powders or of the parts manufactured by sintering from said polyamide or polyamide powders) is measured according to the following steps:
taking samples of polymer of between 0.07 and 0.10 g and preferably of 0.15 g maximum,
adding a sufficient amount of m-cresol solvent by weighing in order to obtain a concentration (C) of 0.5 g/l,
heating the mixture with stirring on a hot plate, regulated at 100° C.±5° C., until the polymer has completely dissolved,
cooling the solution to room temperature, preferably for at least 30 minutes,
measuring the flow time t0 of the pure solvent and the flow time t of the solution using a micro-Ubbelohde tube viscometer in a thermostatically-controlled bath regulated at 20° C.±0.05° C.,
calculating the viscosity according to the formula 1/C×Ln (t/t0), where C represents the concentration and Ln the natural logarithm.

For each sample, three measurements are taken on different solutions, then the mean is calculated.

The thermal characteristics of the polyamide are analyzed by DSC according to the standard ISO 11357-3 “Plastics—Differential Scanning Calorimetry (DSC) Part 3: Determination of temperature and enthalpy of melting and crystallization”. The temperatures that more particularly concern the invention herein are the first-heat melting point (Mp1), the crystallization temperature (Tc) and the enthalpy of fusion.

“Semicrystalline thermoplastic polymer” means a thermoplastic polymer which has:
a crystallization temperature (Tc) determined, according to the standard ISO 11357-3:2013, during the step of cooling at a rate of 20 K/min in DSC (differential scanning calorimetry);
a melting point (Mp) determined, according to the standard ISO 11357-3:2013, during the step of heating at a rate of 20 K/min in DSC; and
an enthalpy of fusion (ΔHf) determined, according to the standard ISO 11357-3:2013, during the step of heating at a rate of 20 K/min in DSC, which is greater than 5 J/g, preferably greater than 10 J/g, for example greater than 20 J/g, and is generally less than 200 J/g, preferably less than 150 J/g, for example less than 100 J/g, or less than 50 J/g.

The yellowing is quantified by the yellowness index (YI) measured according to the standard ASTM E313-96 (D65), particularly using a Konica Minolta spectrocolorimeter with the illuminant D65 at 100 in specular component included (SCI) mode.

The mechanical properties, particularly the tensile modulus and the elongation at break, are measured according to the standard ISO 527-1B: 2012.

In the present description, it is noted that when reference is made to ranges, expressions of the type “between . . . and . . . ” include the limits of the range.

Unless otherwise mentioned, the percentages expressed are percentages by weight. Unless otherwise mentioned, the parameters to which reference is made are measured at atmospheric pressure and at room temperature (23° C.).

The nomenclature used to denote the polyamides follows the standard ISO 1874-1:2011. The term “monomer” in the present description of the polyamides should be taken as meaning “repeat unit”. In particular, in the PA “XY” notation denoting a polyamide resulting from the condensation of a diamine with a dicarboxylic acid, X represents the number of carbon atoms of the diamine and Y represents the number of carbon atoms of the dicarboxylic acid. In the PA “Z” notation, Z represents the number of carbon atoms of the polyamide units resulting from the condensation of an amino acid or lactam. The notations PA X/Y, PA X/Y/Z, etc. (referred to in the context of the invention as PA “X/Y”), relate to copolyamides in which X, Y, Z, etc., represent homopolyamide units X, Y, Z as described in the present invention.

Thermoplastic polymer Preferably, the thermoplastic polymer is a semicrystalline thermoplastic polymer, preferably a polyamide.

The polyamide can be a homopolyamide (i.e. PA “XY” and PA “Z”), a copolyamide (i.e. PA “X/Y”), or mixtures thereof.

“Z”-type polyamides result from the condensation of one or more α,ω-aminocarboxylic acids and/or of one or more lactams.

Mention may be made, by way of example of α,ω-aminocarboxylic acid, of α,ω-amino acids, such as aminocaproic acid, 7-aminoheptanoic acid, 11-aminoundecanoic acid, n-heptyl-11-aminoundecanoic acid and 12-aminododecanoic acid.

Mention may be made, by way of example of lactams, of those having from 3 to 12 carbon atoms on the main ring and which may be substituted. Mention may be made, for example, of β,β-dimethylpropiolactam, α,α-dimethylpropiolactam, amylolactam, caprolactam, capryllactam, enantholactam, 2-pyrrolidone and lauryllactam.

By way of example of this type of preferred polyamides, mention may be made of PA 6, PA 11 and PA 12.

“XY”-type polyamides originate from the condensation of a dicarboxylic acid with an aliphatic, cycloaliphatic or aromatic diamine.

Mention may be made, by way of example of diamine, of aliphatic diamines having from 6 to 12 atoms, it also being possible for the diamine X to be aryl and/or saturated cyclic. By way of examples, mention may be made of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPDM), bis(aminocyclohexyl)methane (BACM), bis(3-methyl-4-aminocyclohexyl)methane (BMACM), meta-xylylenediamine, trimethylhexamethylenediamine.

By way of examples of dicarboxylic acid, mention may be made of acids having between 4 and 18 carbon atoms, preferably from 9 to 12 carbon atoms. Mention may be made, for example, of adipic acid, sebacic acid, azelaic acid, suberic acid, isophthalic acid, butanedioic acid, 1,4-cyclohexanedicarboxylic acid, terephthalic acid, the sodium or lithium salt of sulfoisophthalic acid, dimerized fatty acids (in particular those having a dimer content of at least 98% and/or preferably being hydrogenated) and 1,2-dodecanedioic acid HOOC—(CH₂)₁₀—COOH.

Examples of this type of preferred polyamides are PA 612, resulting from the condensation of hexamethylenediamine and of 1,12-dodecanedioic acid; PA 613, resulting from the condensation of hexamethylenediamine and of brassylic acid; PA 912, resulting from the condensation of 1,9-nonanediamine and of 1,12-dodecanedioic acid; PA 1010, resulting from the condensation of 1,10-decanediamine and sebacic acid; PA 1012, resulting from the condensation of 1,10-decanediamine and of 1,12-dodecanedioic acid.

The polyamide can also be a copolyamide resulting from the condensation:
of at least two different monomers, for example of at least two different α,ω-aminocarboxylic acids, or
of two different lactams, or
of a lactam and of an α,ω-aminocarboxylic acid having different carbon numbers, or
of at least one α,ω-aminocarboxylic acid (or a lactam), at least one diamine and at least one dicarboxylic acid, or
of an aliphatic diamine with an aliphatic dicarboxylic acid and at least one other monomer chosen from aliphatic diamines other than the preceding one and aliphatic diacids other than the preceding one.

Use may also be made of mixtures of polyamides, which may be mixtures of aliphatic polyamides and of semiaromatic polyamides and mixtures of aliphatic polyamides and of cycloaliphatic polyamides.

The polyamide of the present invention can also be a copolymer having polyamide blocks and polyether blocks (PEBA) or a mixture of a copolymer having polyamide blocks and having polyether blocks with at least one of the abovementioned polyamides.

PEBA copolymers can result from the copolycondensation of polyamide blocks having reactive ends with polyether blocks having reactive ends, such as, inter alia:
1) polyamide blocks having diamine chain ends with polyoxyalkylene blocks having dicarboxylic chain ends;
2) polyamide blocks having dicarboxylic chain ends with polyoxyalkylene blocks having diamine chain ends;
3) polyamide blocks having dicarboxylic chain ends with polyetherdiols, the products obtained being, in this specific case, polyetheresteramides.

The polyamide blocks can be a homopolyamide or a copolyamide as described above for homopolyamides and copolyamides.

The polyamide blocks having dicarboxylic chain ends originate, for example, from the condensation of polyamide precursors in the presence of a dicarboxylic acid-type chain limiter. The polyamide blocks having diamine chain ends originate, for example, from the condensation of polyamide precursors in the presence of a diamine-type chain limiter.

The polyether blocks of the PEBA can result from alkylene glycols, such as PEG (polyethylene glycol), PPG (polypropylene glycol), PO3G (polytrimethylene glycol) or PTMG (polytetramethylene glycol), preferably PTMG.

The polymers having polyamide blocks and polyether blocks can comprise randomly distributed units. These polymers can be prepared by the simultaneous reaction of the polyether and of the precursors of the polyamide blocks.

The polyether diol blocks are either used in unmodified form and copolycondensed with polyamide blocks having carboxylic end groups, or they are aminated to be converted into polyetherdiamines and condensed with polyamide blocks having carboxylic end groups.

They can also be mixed with polyamide precursors and a chain limiter in order to make polymers having polyamide blocks and polyether blocks which have randomly distributed units.

The ratio of the amount of copolymer having polyamide blocks and polyether blocks to the amount of polyamide is advantageously between 1/99 and 15/85 by weight.

As regards the mixture of polyamide and of at least one other polymer, it is provided in the form of a mixture having a polyamide matrix and the other polymer(s) form(s) the dispersed phase. Mention may be made, as examples of this other polymer, of polyolefins, polyesters, polycarbonate, PPO (abbreviation for polyphenylene oxide), PPS (abbreviation for polyphenylene sulfide) or elastomers.

Preferably, the powder compositions comprise at least one polyamide chosen from polyamides, copolyamides and/or PEBA copolymers comprising at least one of the following XY or Z monomers: 46, 4T, 54, 59, 510, 512, 513, 514, 516, 518, 536, 6, 64, 66, 69, 610, 612, 613, 614, 616, 618, 636, 6T, 9, 104, 109, 1010, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14, and mixtures thereof; in particular chosen from PA 6, PA 11, PA 12, PA 612, PA 613, PA 912, PA 1010, PA1012 6, PA 6/12, PA 11/1010, and mixtures thereof.

### Thioether

The powder of the invention can advantageously comprise a thioether.

The thioether is preferably selected from: dilauryl thiodipropionate (DLTDP), ditridecyl thiodipropionate (DTDTDP), distearyl thiodipropionate (DSTDP), dimyristyl thiodipropionate (DMTDP), pentaerythrityl tetrakis(3-dodecylthiopropionate or 3-laurylthiopropionate), 3,3′-thiodipropionate, (C12-14)alkyl thiopropionate, dilauryl 3,3′-thiodipropionate, ditridecyl 3,3′-thiodipropionate, dimyristyl 3,3′-thiodipropionate, distearyl 3,3′-thiodipropionate, dioctadecyl 3,3′-thiodipropionate, lauryl stearyl 3,3-thiodipropionate, tetrakis[methylene 3-(dodecylthio)propionate]methane, thiobis(2-tert-butyl-5-methyl-4,1-phenylene)bis(3-(dodecylthio)propionate), 2,2′-thiodiethylenebis(3-aminobutenoate), 4,6-bis(octylthiomethyl)-o-cresol, 2,2′-thiodiethylenebis 3-(3,5-tert-butyl-4-hydroxyphenyl) propionate, 2,2′-thiobis(4-methyl 6-tert-butylphenol), 2,2′-thiobis(6-tert-butyl-p-cresol), 4,4′-thiobis(6-tert-butyl-3-methylphenol), 4,4′-thiobis(4-methyl-6-tert-butylphenol), bis(4,6-tert-butyl-1-yl-2-) sulfide, tridecyl-3,5-di-tert-butyl-4-hydroxybenzyl thioacetate, 1,4-bis(octylthiomethyl)-6-phenol, 2,4-bis(dodecylthiomethyl)-6-methylphenol, distearyl disulfide, bis(methyl-4-3-n-(C12/C14)alkyl thiopropionyloxy 5-tert-butylphenyl) sulfide, and/or mixtures thereof.

More preferably, the thioether according to the invention is selected from the group consisting of dilauryl thiodipropionate (DLTDP), ditridecyl thiodipropionate (DTDTDP), distearyl thiodipropionate (DSTDP), dimyristyl thiodipropionate (DMTDP), pentaerythrityl tetrakis(3-dodecylthiopropionate or 3-laurylthiopropionate), and/or mixtures thereof.

Even more preferably, the thioether is DLTDP.

Even more preferably, the thioether is pentaerythrityl tetrakis(3-dodecylthiopropionate).

Such a compound is sold particularly by Songnox, or Adeka under the trade name ADK STAB AO-412S.

Preferably, the thioether has a melting point of less than or equal to 180° C., preferably less than or equal to 160° C., preferentially less than or equal to 140° C., even more preferentially less than or equal to 130° C., or to 100° C.

### Polymer Powder

According to one embodiment, the polymer powder according to the invention comprises a thermoplastic polymer (a), a sulfonate (b), and optionally a thioether (c), fillers or reinforcements (d), and/or one or more additional additives (e).

According to one embodiment, the powder according to the invention comprises:
(a) 30% to 99.9%, preferably 40% to 95%, by weight of a thermoplastic polymer as defined above;
(b) 0.1% to 10%, preferably 0.1% to 5%, by weight of a sulfonate as defined above;
(c) 0% to 5%, preferably 0.1% to 1%, by weight of a thioether as defined above;
(d) 0% to 50%, preferably 10% to 50%, and in particular 20% to 40%, by weight of fillers or reinforcements; and
(e) 0% to 10%, preferably 0.1% to 7.5%, in particular 1% to 5%, by weight of additional additives,
the respective proportions of the components (a), (b), (c), (d) and (e) adding up to 100%.

According to one embodiment, the powder according to the invention comprises:
(a) 75% to 99.9%, preferably 85% to 99%, by weight of a thermoplastic polymer as defined above;
(b) 0.1% to 10%, preferably 0.1% to 5%, by weight of a sulfonate as defined above;
(c) 0% to 5%, preferably 0.1% to 1%, by weight of a thioether as defined above;
(e) 0% to 10%, preferably 0.1% to 7.5%, in particular 1% to 5%, by weight of additional additives,
the respective proportions of the components (a), (b), (c) and (e) adding up to 100%.

The component (e) can comprise one or more of these additives.

According to one embodiment, the sulfonate represents from 0.1% to 3% or from 3% to 5%, or from 5% to 10%, or from 10% to 15%, or from 15% to 20%, by weight relative to the total weight of the polymer powder. In particular, the sulfonate can represent from 0.5% to 10% by weight, or from 0.5% to 5% by weight, relative to the total weight of the polymer powder.

Preferably, the thioether represents at least 0.1%, preferably from 0.1% to 5%, preferably from 0.1% to 3%, preferably from 0.1% to 2%, preferably from 0.1% to 1%, by weight relative to the total weight of the polymer powder.

Typically, the thioether represents at least 0.2%, for example at least 0.3%, typically at least 0.4%, and typically less than 5%, for example less than 4%, preferably less than 3%, by weight relative to the total weight of the polymer powder.

Preferably, the polymer powder has a first-heat melting point (Mp1) of between 80 and 220° C., preferably of between 100 and 200° C.

The powder can have a crystallization temperature (Tc) of from 40 to 250° C., and preferably from 45 to 200° C., for example from 45 to 150° C.

When a mixture of polymers (a) is concerned, the lowest Mp in the mixture is regarded as the Mp and the highest Tc in the mixture is regarded as the Tc.

The difference between the Tc and the Mp of the powder is preferably greater than or equal to 20° C., or more preferably still greater than or equal to 30° C.

According to one embodiment, the inherent viscosity in solution of the powder, before use thereof in a sintering process, is typically less than 3, preferably less than 2.

Preferably, the inherent viscosity of the powder not affected by the electromagnetic radiation after a first build in a sintering process is between 0.8 and 3, preferably between 1 and 2.

Typically, the polymer powder according to the invention has a Dv50 diameter of 40 to 150 μm and preferably of 40 to 100 μm. For example, the Dv50 diameter of the polymer powder can be from 40 to 45 am; or from 45 to 50 μm; or from 50 to 55 μm; or from 55 to 60 μm; or from 60 to 65 μm; or from 65 to 70 μm; or from 70 to 75 μm; or from 75 to 80 μm; or from 80 to 85 μm; or from 85 to 90 μm; or from 90 to 95 μm; or from 95 to 100 μm; or from 100 to 105 μm; or from 105 to 110 μm; or from 110 to 115 μm; or from 115 to 120 μm; or from 120 to 125 μm; or from 125 to 130 μm; or from 130 to 135 μm; or from 135 to 140 μm; or from 140 to 145 μm; or from 145 to 150 μm.

### Fillers and Reinforcements

The polymer powder according to the invention can moreover optionally comprise fillers or reinforcements, in particular in order to ensure that the printed article has satisfactory mechanical properties, in particular in terms of modulus. These fillers can in particular be carbonate minerals, in particular calcium carbonate, magnesium carbonate, dolomite rock, calcite, barium sulfate, calcium sulfate, dolomite mineral, alumina hydrate, wollastonite, montmorillonite, zeolite, perlite or nanofillers (fillers having a dimension of the order of a nanometer), such as nanoclays, calcium silicates, magnesium silicates, such as talcum, mica, kaolin, attapulgite, and mixtures thereof. Mention may particularly be made, as reinforcements, of carbon nanotubes, glass powder, glass fibers and carbon fibers, and also solid or hollow glass beads optionally coated with silane. The component (c) can comprise one or more fillers and/or reinforcements. Advantageously, the fillers and reinforcements do not comprise pigments as defined below for the pigment composition.

More specifically, the powder of the invention can comprise 0% to 60% or from 5% to 50% or from 10% to 40% or from 10% to 30% by weight of component (c). According to one embodiment, the polymer powder is devoid of fillers and reinforcements.

### Additional Additives

The polymer powder can comprise, where appropriate, additional additives that are customary in polymer powders used in 3D printing by sintering.

These can in particular be additives, whether in powder form or not, which contribute to improving the behavior of the powder in 3D printing by sintering and those which make it possible to improve the properties of the printed articles, in particular the mechanical strength, thermal resistance, fire resistance, and in particular the elongation at break and the impact strength.

These customary additives can in particular be chosen from flow agents, chain limiters, fireproofing agents, flame retardants, UV stabilizers, antioxidants, anti-abrasion agents, light stabilizers, impact modifiers, antistatic agents, pigments and waxes.

### Flow Agent

By way of examples, the flow agent may for example be chosen from silicas, particularly hydrophobic fumed silica; mention may for example be made of the product sold under the name Cab-o-Sil® TS610 by Cabot Corporation, precipitated silica, hydrated silica, vitreous silica, pyrogenic silica, vitreous oxides, particularly vitreous phosphates, vitreous borates, alumina, such as amorphous alumina, and mixtures thereof.

### Antioxidant

For example, the powder of the invention may comprise a phenolic antioxidant such as 3,3′-bis(3,5-di-tert-butyl-4-hydroxyphenyl)-N,N′-hexamethylenedipropionamide, particularly sold under the name Palmarole AO.OH.98 by Palmarole, (4,4′-butylidenebis(2-t-butyl-5-methylphenol), particularly sold under the name Lowinox® 44B25 by Addivant, pentaerythrityl tetrakis(3-(3,5-di-tert-butyl-4-hydroxyphenyl)propionate), particularly sold under the name Irganox® 1010 by BASF, N,N′-hexane-1,6-diylbis(3-(3,5-di-tert-butyl-4-hydroxyphenylpropionamide)), particularly sold under the name Irganox® 1098 by BASF, 3,3′,3′,5,5′,5′-hexa-tert-butyl-α,α′,α′-(mesitylene-2,4,6-triyl)tri-p-cresol, particularly sold under the name Irganox® 1330 by BASF, ethylenebis(oxyethylene)bis(3-(5-tert-butyl-4-hydroxy-m-tolyl)propionate), particularly sold under the name Irganox® 245 by BASF, 1,3,5-tris(3,5-di-tert-butyl-4-hydroxybenzyl)-1,3,5-triazine-2,4,6(1H,3H,5H)-trione, particularly sold under the name Irganox® 3114 by BASF, N‘N’-(2-ethyl-2′-ethoxyphenyl)oxanilide, particularly sold under the name Tinuvin® 312 by BASF, [(4,4′,4″-trimethyl-1,3,5-benzenetriyl)tris(methylene)]tris 2,6-bis(1,1-dimethylethyl)phenol, particularly sold under the name Alvinox® 1330 by 3V, Hostanox® 245 FF, Hostanox® 245 Pwd, sold by Clariant, pentaerythrityl tetrakis(3-(3,5-di-tert-butyl-4-hydroxyphenyl)propionate), particularly sold under the names Evernox® 10 and Evernox® 10GF by Everspring Chemical Company Limited, octadecyl 3-(3,5-di-tert-4-hydroxyphenyl)propionate, particularly sold under the names Evernox® 76 and Evernox® 76GF by Everspring Chemical Company Limited, tetrakis[methylene-3-(3′,5′-di-tert-butyl-4-hydroxyphenyl) propionate]methane, particularly sold under the name BNX© 1010 by Mayzo, thiodiethylenebis[3-(3,5-di-tert-butyl-4-hydroxyphenyl)propionate], particularly sold under the name BNX® 1035 by Mayzo, tetrakis[methylene-3-(3′,5′-di-tert-butyl-4-hydroxyphenyl)propionate]methane, octadecyl 3-(3,5-di-tert-butyl-4-hydroxyphenyl)propionate, particularly sold under the name BNX© 2086 by Mayzo, and 1,3,5-tris(3,5-di-tert-butyl-4-hydroxybenzyl)-1,3,5-triazine-2,4,6(1H,3H,5H)trione, particularly sold under the name BNX® 3114 by Mayzo.

The powder can also comprise antioxidants such as compounds comprising aromatic or aliphatic phosphonites (such as the product Hostanox® P-EPQ® sold by Clariant), alkali metal salts of phenylphosphonic acid or of hypophosphorus acid, compounds comprising phosphite functions, such as trialkyl and trialkylaryl phosphites, and cyclic diphosphites derived from pentaerythritol. Mention may be made of Irgafos® 168 sold by BASF. As examples of trialkyl and trialkylaryl phosphites, mention may be made of trinonyl, tri(nonylphenyl) and tri[(2,4-di-tert-butyl-5-methyl)phenyl] phosphites. As examples of cyclic diphosphites derived from pentaerythritol, mention may be made of distearyl pentaerythritol diphosphite.

### Pigments

The pigment can be a pigment having absorbance of light with a wavelength of 1000 nm, as measured according to the standard ASTM E1790, of less than 40%, for example chosen from metal and transition metal oxides and also the corresponding mixtures, mixed oxides and doped oxides thereof. For example, an oxide chosen from titanium, tin, magnesium, copper, zinc, iron, manganese, cobalt, nickel, aluminum, antimony, chromium, titanium or silicon oxides or corresponding mixtures, mixed oxides or doped oxides thereof.

### Wax

The wax may comprise a wax of polyethylene and polypropylene, of polytetrafluoroethylene, of ketones, of acid, of partially esterified acid, of acid anhydride, of ester, of aldehydes, of amides, derivatives thereof and mixtures thereof. The wax may particularly comprise a product sold under the name Crayvallac® WN1135, WN 1495 or WN1265 by Arkema or a product sold under the name Ceridust® 9615A or 8020 by Clariant.

According to one embodiment, the wax is present in the composition in the form of a coating at least partially covering the polymer powders.

### Chain Limiter

The powder of the invention can comprise a chain limited chosen from dicarboxylic acids, monocarboxylic acids, diamines and monoamines, each of which may be linear or cyclic.

Preferably, the chain limiter has a melting point of less than 180° C.

The monocarboxylic acid preferably has from 2 to 20 carbon atoms. As examples of monocarboxylic acid, mention may be made of acetic acid, propionic acid, benzoic acid and stearic acid, lauric acid, butanoic acid, pentanoic acid, hexanoic acid, heptanoic acid, octanoic acid, nonanoic acid, decanoic acid, undecanoic acid, acrylic acid, methacrylic acid, crotonic acid, cinnamic acid, hexadecanoic acid, octodecanoic acid and tetradecanoic acid. The dicarboxylic acid preferably has from 2 to 20 carbon atoms, more preferably from 6 to 10 carbon atoms. As examples of dicarboxylic acid, mention may be made of sebacic acid, adipic acid, azelaic acid, suberic acid, dodecanedicarboxylic acid, butanedioic acid and ortho-phthalic acid.

The monoamine may particularly be a primary amine having from 2 to 18 carbon atoms. As examples of monoamine, mention may be made of 1-aminopentane, 1-aminohexane, 1-aminoheptane, 1-aminooctane, 1-aminononane, 1-aminodecane, 1-aminoundecane, 1-aminododecane, benzylamine and oleylamine.

The diamine may in particular be a primary diamine comprising from 4 to 20 carbon atoms. As examples of diamine, mention may be made of the isomers of bis(4-aminocyclohexyl)methane (BACM), bis(3-methyl-4-aminocyclohexyl)methane (BMACM) and 2,2-bis(3-methyl-4-aminocyclohexyl)propane (BMACP), and para-aminodicyclohexylmethane (PACM), isophoronediamine (IPDA), 2,6-bis(aminomethyl)norbornane (BAMN) and piperazine.

According to one embodiment, the chain limiter represents from 0.01% to 10%, preferably from 0.01% to 5%, preferably from 0.01% to 4%, preferably from 0.01% to 3%, preferably from 0.01% to 2%, preferably from 0.01% to 1% by weight relative to the total weight of the thermoplastic polymer or relative to the total weight of the polyamide when the thermoplastic polymer is a polyamide.

The chain limiter may represent from 0.01% to 2% by weight relative to the total weight of the thermoplastic polymer or relative to the total weight of the polyamide when the thermoplastic polymer is a polyamide.

Preferably, the chain limiter represents from 0.01% to 0.5%, from 0.01% to 0.4%, from 0.01% to 0.3%, from 0.01% to 0.2% by weight relative to the total weight of the thermoplastic polymer or relative to the total weight of the polyamide when the thermoplastic polymer is a polyamide.

### Process for Preparing the Polymer Powder

The polymer powder can be manufactured according to the usual processes.

Use may be made of commercially available thermoplastic polymers (component (a)), in particular in the form of granules, flakes or powder. If necessary, the component (a) can be converted into powder, by means of known processes, in particular by grinding.

The grinding can be grinding at room temperature.

Alternatively, the grinding can be cryogenic grinding. In this process, the material to be ground is cooled, for example by means of liquid nitrogen, liquid carbon dioxide or liquid helium, in order to make the material more brittle and consequently facilitate grinding.

The grinding can be carried out, for example, in a pin mill, a hammer mill or a whirl mill.

In this case, the process for preparing a powder according to the invention comprises the steps of:
(i) grinding a thermoplastic polymer (a) to give a powder with a Dv50 diameter of 40 to 150 μm, before or after,
(ii) introducing at least one sulfonate (b) as defined above, and also one or more components (c) to (e), where appropriate.

Components can be added to the thermoplastic polymer (component (a)) before grinding according to methods known to those skilled in the art.

By way of examples, the addition can be performed in the melt state, for example in an extruder (compounding) or by wet impregnation (reference can be made for example to the method described in EP 3 325 535 B1).

In the case in which the components are added after the grinding, for example by dry blending, it is preferable for the components to be in pulverulent form with a Dv suitable for 3D printing.

As an alternative, the sulfonate (component (b)), and, where appropriate, one or more components (c) to (e), can be added to the thermoplastic polymer during synthesis thereof.

In this case, the process for preparing a powder according to the invention comprises the steps of:
(i) synthesizing a thermoplastic polymer (a), during or after,
(ii) introducing at least one sulfonate (b) as defined above, and also one or more components (c) to (e), where appropriate.

For example, it is possible to mix the components by means of coprecipitation of the polymer from a solution in the presence of the additive component(s) (dissolution/precipitation). The conditions can be readily adapted by those skilled in the art. Reference may for example be made to document EP 0863174 B1.

It is also possible to mix the components with a prepolymer of the component (a), during or after the synthesis of the prepolymer in a process as described in U.S. Pat. No. 9,738,756, or to mix the components with the prepolymer in the melt phase (compounding), as described in EP 2247646 B1.

As an alternative or in addition, the sulfonate (component (b)), and, where appropriate, one or more components can be added by dry blending with the thermoplastic polymer (a).

In this case, the process for preparing a powder according to the invention comprises a step in which the sulfonate (b), and, where appropriate, one or more components (c) to (e) are incorporated into the powder by dry blending.

It is also possible to use several of these processes, according to the additives, for their introduction into the polymer composition.

The powder thus obtained can subsequently be sieved or subjected to a selection step in order to obtain the desired particle size profile.

Before use, the polymer powder can subsequently, where appropriate, be subjected to various treatments, in particular heat or hydraulic treatments, in order for it to be better suited to 3D printing by sintering.

The components can be used in any suitable form according to the preparation method.

According to one embodiment, one or more components are used in powder form. The shape and the size of the particles forming the powder are not particularly limited, except by the application of 3D printing by sintering. The particles commonly have a spherical shape. However, their use in other shapes, such as in the form of rods or in lamellar form, is not excluded.

When the components are added to the dry-blend polymer, they advantageously have a volume-median diameter Dv50 substantially equal to or less than that of the powder with which they will be mixed. More specifically, the volume-median diameter Dv50 of the components is preferably between 0.01 and 50 μm, preferably between 0.05 and 30 μm, more preferably between 0.1 and 20 am, in particular between 0.2 and 10 am and most particularly between 0.5 and 5 μm.

The invention will be further explained, non-limitingly, with the aid of the following example.

### EXAMPLES

The examples below illustrate the present invention without limiting the scope thereof. In the examples, unless otherwise indicated, all the percentages and parts are expressed by weight.

Although the tests refer to a powder composition based on polyamide 11, it is understood that the compositions according to the present invention are not limited to this embodiment but can comprise any type of polymer, particularly of polyamide, alone or as a mixture.

### Example I

The base powder 1 used is a powder containing 99.2% by weight of polyamide 11; 0.6% by weight of an antioxidant, N,N′-1,6-hexanediylbis[3-(3,5-bis(1,1-dimethylethyl)-4-hydroxyphenylpropanamide)]; and 0.2% by weight of a flow agent (hydrophobic fumed silica), relative to the total weight of the base powder 1.

The polyamide 11 was prepared according to the method described in EP 2247646 B1, in which the antioxidant was incorporated in the polyamide prepolymer by compounding.

The flow agents was subsequently added by dry blending, as follows.

The compounds to be mixed are introduced into a Henschel IAM 6 L mixer in the proportions indicated above, and stirring is carried out at 900 rpm for 100 s at room temperature.

The Dv50 of the powder measured is 50 μm.

For examples 2 to 3, a sulfonate is added to the polymer powder by dry blending, as follows.

The polyamide powder is introduced with a sulfonate into a Henschel IAM 6 L mixer in the proportions indicated in table 1 below, and stirring is carried out at 900 rpm for 100 s at room temperature.

TABLE 1

| | Base powder | Hostapon ® | Hostapon ® |
|---|---|---|---|
| | 1(% by | TPHC (% by | SCI 85 (% |
| Ex. | weight) | weight) | by weight) |
| 1 (comparative) | 100 | 0 | 0 |
| 2 | 99 | 1 | 0 |
| 3 | 99 | 0 | 1 |

Hostapon ® TPHC is a sodium 2-(methyloleoylamino)ethane-1-sulfonate product sold by Clariant.
Hostapon ® SCI 85 is a 2-butanoyloxyethanesulfonate (also referred to as sodium cocoyl isethionate) product sold by Clariant.

### Aging Test and Measurement of the Yellowness Index (YI) of the Powder

### a) In the Solid State

The test consists in exposing the powder of the examples at 177° C. in a glass bottle placed in an air-ventilated oven for 72 h. The results are shown in table 2.

This test simulates the exposure conditions to which a powder might be subjected in a 3D printer. The measurements of the yellowness index (YI) are taken on a Konica Minolta spectrocolorimeter with the illuminant D65 at 100 in specular component included (SCI) mode, according to the standard ASTM (E313-96) (D65).

### b) In the Melt State

The test consists in exposing the powder of the examples at 220° C. in an aluminium crucible placed in an air-ventilated oven for 2 h (powder layer approximately 2 mm thick).

The molten film is subsequently detached and the measurement is performed by placing it in front of the white part of a Leneta form 2A opacity chart.

This test simulates the exposure conditions to which a part might be subjected in a 3D printer as the part is being built.

The measurements of the yellowness index (YI) are taken on a Konica Minolta spectrocolorimeter with the illuminant D65 at 100 in SCI mode, according to the standard ASTM (E313-96) (D65). The results are shown in table 2.

TABLE 2

| | | YI (72 h at 177° | YI (2 h at 220° |
|---|---|---|---|
| | YI t0 (23° C.) | C. under air) | C. under air) |
| | ASTM (E313-96) | ASTM (E313-96) | ASTM (E313-96) |
| | (D65)/10° in SCI | (D65)/10° in SCI | (D65)/10° in SCI |
| Ex. | (solid state test) | (solid state test) | (melt state test) |
| 1 (comp- | 4 | 51 | 102 |
| arative) | | | |
| 2 | 5 | 47 | 83 |
| 3 | 3 | 44 | 83 |

During the aging tests in the solid and melt states, it was observed that the yellowness index values are lower for a powder comprising a sulfonate (examples 2 and 3) compared to a powder without the sulfonate (example 1). Thus, the use of a sulfonate in a polyamide powder made it possible to improve the color stability of the powder, and also the color stability of the printed part.

### Example II

The base powder 2 and 3 used comprise 98.9% by weight of a polyamide 11; 0.4% by weight of an antioxidant, triethylene glycol bis(3-tert-butyl-4-hydroxy-5-methylphenyl)propionate; 0.2% by weight of a flow agent (hydrophobic fumed silica), and 0.5% by weight of a thioether, relative to the total weight of the base powder. The Dv50 of the powder measured is 50 μm.

The thioether used in the base powder 2 is a pentaerythrityl tetrakis(3-dodecylthiopropionate) sold by Adeka.

The thioether used in the base powder 3 is a dilauryl thiodipropionate (DLTDP) sold by Songnox.

The base powders 2 and 3 were prepared according to the method as described in EP 2247646 B1, in which the antioxidant and the thioether were added to the polymer by compounding. The flow agent was subsequently added into the powder by dry blending according to the method described in example I.

For examples 6 to 9, an additional sulfonate is added to the base powders by dry blending, according to the method described in example I.

TABLE 3

| | Base | Base | Hostapon ® | Dodecane- | Heptane- |
|---|---|---|---|---|---|
| | powder 2 | powder 3 | SCI 85 | sulfonate | sulfonate |
| | (% by | (% by | (% by | (% by | (% by |
| Ex. | weight) | weight) | weight) | weight) | weight) |
| 4 (comp- | 100 | 0 | 0 | 0 | 0 |
| arative) | | | | | |
| 5 (comp- | 0 | 100 | 0 | 0 | 0 |
| arative) | | | | | |
| 6 | 0 | 99 | 1 | 0 | 0 |
| 7 | 99 | 0 | 0 | 1 | 0 |
| 8 | 99 | 0 | 0 | 0 | 1 |
| 9 | 99 | 0 | 1 | 0 | 0 |

### Aging Test and Measurement of the Yellowness Index (YI) of the Powder

The aging tests in the solid and melt states were performed according to the protocol described in example I.

TABLE 4

| | | YI (72 h at 177° | YI (2 h at 220° |
|---|---|---|---|
| | YI t0 (23° C.) | C. under air) | C. under air) |
| | ASTM (E313-96) | ASTM (E313-96) | ASTM (E313-96) |
| | (D65)/10° in SCI | (D65)/10° in SCI | (D65)/10° in SCI |
| Ex. | (solid state test) | (solid state test) | (melt state test) |
| 4 (comp- | 5 | 33 | 99 |
| arative) | | | |
| 5 (comp- | 3 | 29 | — |
| arative) | | | |
| 6 | 4 | 17 | — |
| 7 | 3 | 21 | — |
| 8 | 5 | 22 | — |
| 9 | 4 | 18 | 67 |

During the aging tests in the solid and melt states, it was observed that the yellowness index values are lower for a powder comprising a sulfonate (examples 6 to 9) compared to a powder without the sulfonate (examples 4 to 5). Thus, the use of a sulfonate in a polyamide powder containing a thioether made it possible to highly advantageously improve the color stability of the powder, and also the color stability of the printed part.

### Inherent Viscosity of the Powder

The inherent viscosity is measured at 20° C., in solution at 0.5% by mass in meta-cresol according to the standard ISO 307:2007.

Example 9 (with sulfonate) of table 5 shows that the inherent viscosity increases less than the inherent viscosity of examples 4 and 5 (without sulfonate). This shows that the addition of the sulfonate to a powder makes it possible to stabilize the inherent viscosity of said powder, and also to better recycle said powder, because it is less reactive.

TABLE 5

| | Inherent viscosity | Inherent viscosity (after aging |
|---|---|---|
| Ex. | (T0) | for 72 h at 177° C. under air) |
| 4 (comparative) | 1.21 | 1.65 |
| 5 (comparative) | 1.23 | 1.76 |
| 9 | 1.23 | 1.35 |

1. A polymer powder suitable for 3D printing by sintering, comprising a thermoplastic polymer (a), and an aliphatic sulfonate (b) according to formula R—SO₃X, or aromatic sulfonate (b) according to formula R—Y—SO₃X, wherein
R represents a linear or branched, saturated or unsaturated aliphatic carbon-based chain having 4 to 30 carbon atoms, which may comprise a group chosen from ester, amide, carboxylic acid, alcohol, nitrile, ketone and/or aldehyde,
Y represents one or more aromatic rings,
X represents a monovalent ion chosen from the alkali metals.

2. The powder as claimed in claim 1, wherein the sulfonate is chosen from:
an aliphatic sulfonate comprising a linear or branched saturated carbon-based chain having 4 to 12 carbon atoms;
an aliphatic sulfonate comprising a linear or branched unsaturated carbon-based chain having 4 to 30 carbon atoms; and/or
an aliphatic or aromatic sulfonate comprising a linear or branched, saturated or unsaturated carbon-based chain having 4 to 30 carbon atoms, the chain comprising a group chosen from ester, amide, acid, alcohol, nitrile and/or aldehyde.

3. The powder as claimed claim 1, wherein the thermoplastic polymer is a semicrystalline thermoplastic polymer.

4. The powder as claimed in claim 1, further comprising a thioether, fillers or reinforcements and/or one or more additional additives.

5. The powder as claimed in claim 1, comprising:
(a) 30% to 99.9%, by weight of a thermoplastic polymer;
(b) 0.1% to 10%, by weight of a sulfonate;
(c) 0% to 5%, by weight of a thioether;
(d) 0% to 50%, by weight of fillers or reinforcements; and
(e) 0% to 10%, by weight of additional additives,
the respective proportions of the components (a), (b), (c), (d) and (e) adding up to 100%.

6. The powder as claimed in claim 1, comprising:
(a) 75% to 99.9%, by weight of a thermoplastic polymer;
(b) 0.1% to 10%, by weight of a sulfonate;
(c) 0% to 5%, by weight of a thioether;
(e) 0% to 10%, by weight of additional additives,
the respective proportions of the components (a), (b), (c) and (e) adding up to 100%.

7. The powder as claimed in claim 1, wherein the thioether is chosen from: dilauryl thiodipropionate (DLTDP), ditridecyl thiodipropionate (DTDTDP), distearyl thiodipropionate (DSTDP), dimyristyl thiodipropionate (DMTDP), pentaerythrityl tetrakis(3-dodecylthiopropionate or 3-laurylthiopropionate), and/or mixtures thereof.

8. The powder as claimed in claim 1, having a Dv50 diameter of 40 to 150 μm.

9. A process for preparing a powder as claimed in claim 1, comprising the steps of:
(i) grinding a thermoplastic polymer to give a powder with a Dv50 diameter of 40 to 150 μm, before or after,
(ii) introducing at least one sulfonate, and also one or more components, where appropriate.

10. A process for preparing a powder as claimed in claim 5, comprising the steps of:
(i) synthesizing a thermoplastic polymer (a), during or after,
(ii) introducing at least one sulfonate (b) as defined above, and also one or more components (c) to (e), where appropriate.

11. A process for preparing a powder as claimed in claim 5, comprising a step in which the sulfonate (b), where appropriate, one or more components (c) to (e) are incorporated into the powder by dry blending.

12. The method of using a sulfonate as defined in claim 1 for improving the thermal stability of a polymer powder suitable for 3D printing by sintering.

13. The method as claimed in claim 12, wherein said powder comprises a thioether is chosen from: dilauryl thiodipropionate (DLTDP), ditridecyl thiodipropionate (DTDTDP), distearyl thiodipropionate (DSTDP), dimyristyl thiodipropionate (DMTDP), pentaerythrityl tetrakis(3-dodecylthiopropionate or 3-laurylthiopropionate), and/or mixtures thereof.

14. A 3D printing process, using a powder as claimed in claim 1, or a powder composition comprising a non-agglomerated portion of said powder recovered after one or more builds within the same printing process or a different printing process.

15. A manufactured article obtained by the 3D printing process of claim 14.
